(19) United States
(12) Patent Application Publication
(10) Pub. No.: US 2008/0002321 A1
(43) Pub. Date: Jan. 3, 2008

(54) ELECTROSTATIC DISCHARGE PROTECTION OF A CLAMP

(76) Inventors: Bart Sorgeloos, Affligem (BE); Bart Keppens, Gistel (BE); Benjamin Van Camp, Antwerp (BE)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/769,127

(22) Filed: Jun. 27, 2007

Related U.S. Application Data
(60) Provisional application No. 60/817,614, filed on Jun. 29, 2006.

(51) Int. Cl. H02H 9/02

(52) U.S. Cl. 361/57

(57) ABSTRACT

The present invention provides an ESD protection circuit for a ESD clamp such as an SCR in the protection of an integrated circuit. In one embodiment of the invention, the SCR having at least one interspersed high-doped first region formed within a first lightly doped region and at least one interspersed high-doped second region formed within a second lightly doped region. The circuit further comprising at least one guardring connected to at least one trigger tap of the SCR to collect the ESD current to provide for a fast and easier triggering of the SCR.

### CROSS-REFERENCE TO RELATED APPLICATION

This application claims the benefit of U.S. Provisional Application No. 60/817,614 filed on Jun. 9, 2006, contents of which are incorporated herein by reference in its entirety.

### FIELD OF THE INVENTION

This invention generally relates to the field of electrostatic discharge (ESD) protection circuitry and, more specifically, improvements in triggering of the silicon controlled rectifier (SCR) in the protection circuitry of the integrated circuit (IC).

### BACKGROUND OF THE INVENTION

One of the protection strategies for ESD protection is shown in a circuit 100 which utilizes a powerclamp 102, and a local clamp 104 having a series of pn junction diodes 106 as shown in FIG. 1. The local clamp 104 for protection between an IO 108 and VSS (or ground) 110 in this case is a DTSCR. Thus, the input to the DTSCR 104 is the IO 108. There exist also a clamp for protection between a VDD 112 and the VSS 110 i.e. the powerclamp 102. Another element shown in the figure is a pn junction diode, diode-up 114 with a guardring 116 surrounding the diode-up 114 for the protection between the IO 108 and the VDD 112. The guardring 116 as shown is a well tap of the diode-up 114. A well tap is a connection to the well wherein a device (in this example, diode-up 114) is placed. Also shown is a chip capacitance 118 which functions as parasitic capacitance between the Vdd line 112 and the Vss line 110. Note that some additional elements required to have a complete protection scheme are not shown in the circuit 100.

A cross-section diagram of a classical pn junction diode 114 is shown in FIG. 2. The diode 114 exists of a P-doped region 114a and an N-doped region 114b. This can be formed in a substrate 202 of P-well or in a separate well, i.e. N-well, 204. If the diode is in an N-well 204 as shown in FIG. 2, then a parasitic bipolar transistor is formed. The emitter is the P+ doped region 114a in the N-well 204 (i.e. the first node of the diode 114) and the base is the N-well 204 connected by the N-doped region 114b in the N-well 204 (i.e. the second node of the diode 114). The collector is the P-Well or P-substrate 202. Note that all the figures and implementations are shown in a P-substrate technology, however, it is clear to one skilled in the art that implementations in N-substrate or in other processes is also possible in the present invention.

As seen in FIG. 2, there are two different ways where the current can flow. The first direction is intended from the first node to the second node of the diode 114. This is the diode-current. Due the parasitic bipolar transistor (pnp transistor in this example) there is also current flowing to the substrate 202. Substrate current is typical unwanted for noise and latch-up. A first classical technique to prevent that this occurs is to surround the diode with a guardring 116 (i.e. the P+ in the P-substrate 202) as shown in FIG. 2. The pnp-current will flow safely to the guardring 116 connected to the ground, Vss 110.

A second technique to illustrate the implementation of the diode-up 114 is shown in FIG. 3. This second technique includes two finger, in this case two types of pnp transistors. To make the pnp less efficient and to increase the diode current, the N-doped regions 114b are placed at the outside of the SCR 104. Also in the substrate a guardring 116 is present to isolate the diode 114 from the outside circuitry. As discussed above, the guardring 116 is connected to the ground Vss 110.

As seen in the prior art disclosed above, the substrate current from the diode to the SCR is always minimized or safely lead away. This substrate current is thus wasted and not utilized constructively in any means. Moreover, it takes a longer time for the current to trigger the SCR, since this current will not flow through the local clamp 104. Thus, there is a need in the art to make use of this current to help the local clamp to trigger much easier and faster.

### BRIEF DESCRIPTION OF THE DRAWINGS

FIG. 1 depicts an illustration of a prior art circuit diagram of an ESD protection strategy.

FIG. 2 depicts an illustrative prior art cross-section diagram of a classical diode of FIG. 1.

FIG. 3 depicts an illustrative prior art cross-section diagram demonstrating implementation of the multi-finger standard diode of FIG. 1.

FIG. 4 depicts an illustrative circuit diagram of a implementation of the ESD protection circuit in accordance with one embodiment of the present invention.

FIGS. 4A-4D depicts an illustrative current flow of the circuit diagram of FIG. 4.

FIG. 5 depicts an illustrative exemplary circuit diagram of an another implementation of the ESD protection circuit of FIG. 4 in accordance with another embodiment of the present invention.

FIG. 6 depicts an illustrative exemplary circuit diagram of another implementation of the ESD protection circuit applied to the power clamp of FIG. 4 in accordance with another embodiment of the present invention.

FIG. 7 depicts an illustrative exemplary circuit diagram of an alternate implementation of the ESD protection circuit applied to the same trigger tap as the trigger circuit of FIG. 6.

FIGS. 8A and 8B depicts an illustrative exemplary circuit diagram of the ESD protection circuit with the use of the guardring of a trigger diode as another embodiment of the present invention.

FIG. 9 depicts an illustrative exemplary circuit diagram of the ESD protection circuit with use of the guardring of one or more diodes of an Active Source Pump (ASP)-scheme as an even further embodiment of the present invention.

FIG. 10 depicts an illustrative exemplary circuit diagram of the ESD protection circuit with use of the guardring of a PMOS of an inverter stage as another embodiment of the present invention.

FIG. 11 depicts an illustrative exemplary circuit diagram of the ESD protection circuit with the use of the guardring of the output NMOS to inject current in a powerclamp as even further embodiment of the present invention.

FIG. 12 depicts an illustrative exemplary cross-section diagram of the position of the diode with respect to the SCR as another embodiment of the present invention.

FIGS. 13A and 13B depicts an illustrative exemplary cross-section diagram of placement of the gate as a further embodiment of the present invention.

FIGS. 14A and 14B depicts an illustrative exemplary circuit diagram of different positions of a control circuit of FIGS. 13A and 13B.

FIGS. 15A-15C depicts an illustrative exemplary circuit diagram of some examples of control circuits of FIGS. 13A and 13B.

FIG. 16 depicts an illustrative exemplary cross-section diagram of dual case with deep NWell.

FIGS. 17A-17D depicts an illustrative exemplary cross-section diagram of implementation with bulk pumping of the Nwell.

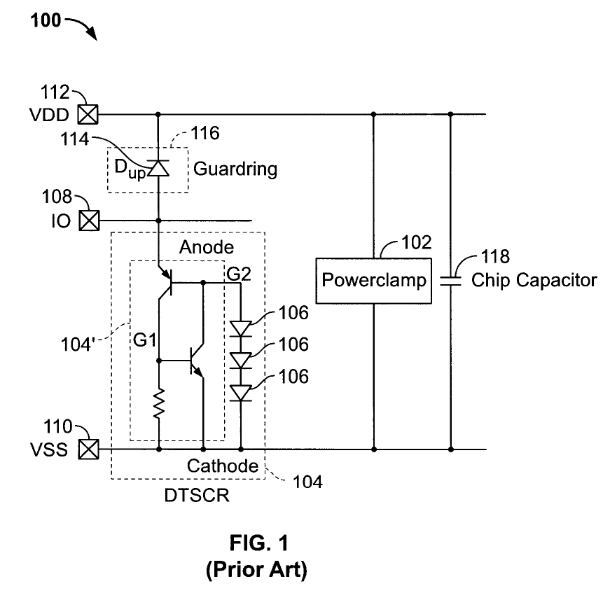

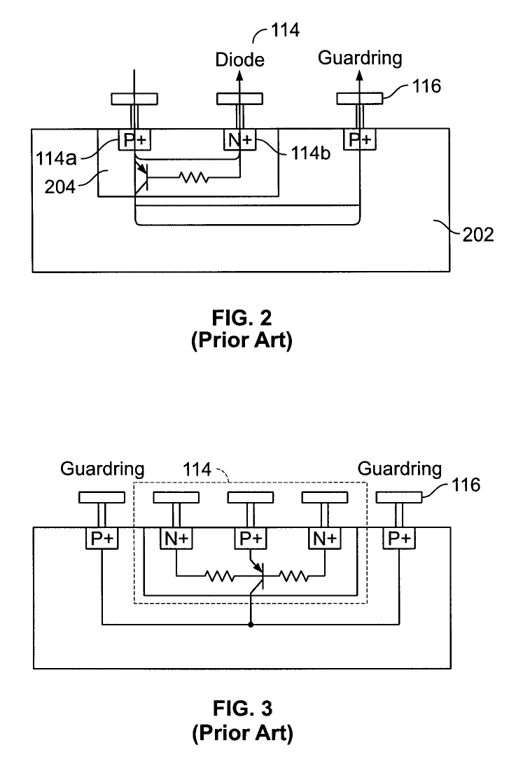

### SUMMARY OF THE INVENTION

In one embodiment of the present invention, there is provided an electrostatic discharge (ESD) protection circuit comprising a SCR having at least one interspersed high-doped first region formed within a first lightly doped region and at least one interspersed high-doped second region formed within a second lightly doped region, said SCR coupled between a first voltage potential and a second voltage potential. The circuit further comprises at least one guardring coupled to at least one trigger tap of the SCR.

In another embodiment of the present invention, there is provided an integrated circuit having a substrate comprising a SCR formed over the said substrate, said SCR having at least one interspersed high-doped first region formed within a first lightly doped region and at least one interspersed high-doped second region formed within a second lightly doped region. The circuit further comprises a pn junction diode directly connected to said SCR without a guardring between the SCR and pn junction.

### DETAILED DESCRIPTION OF THE INVENTION

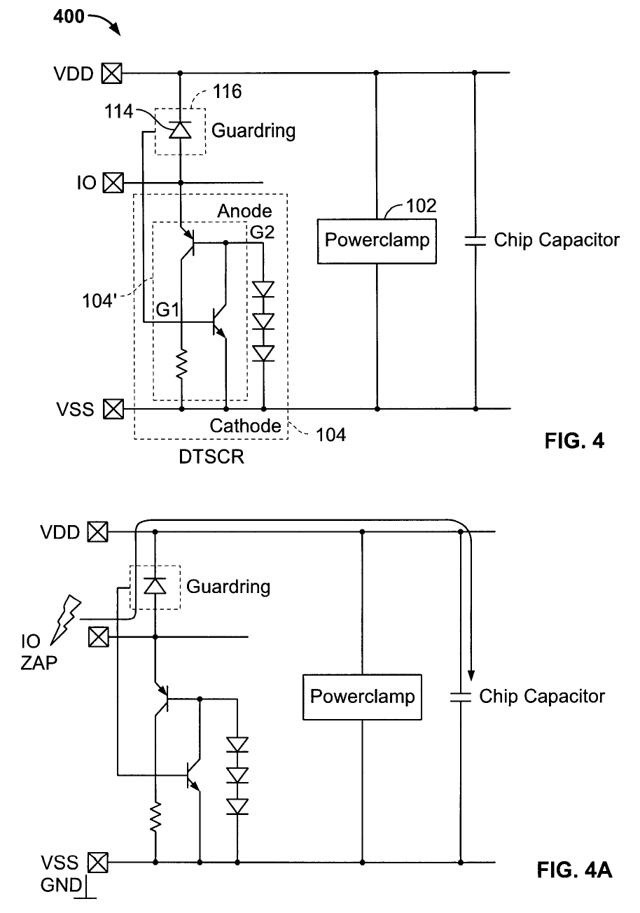

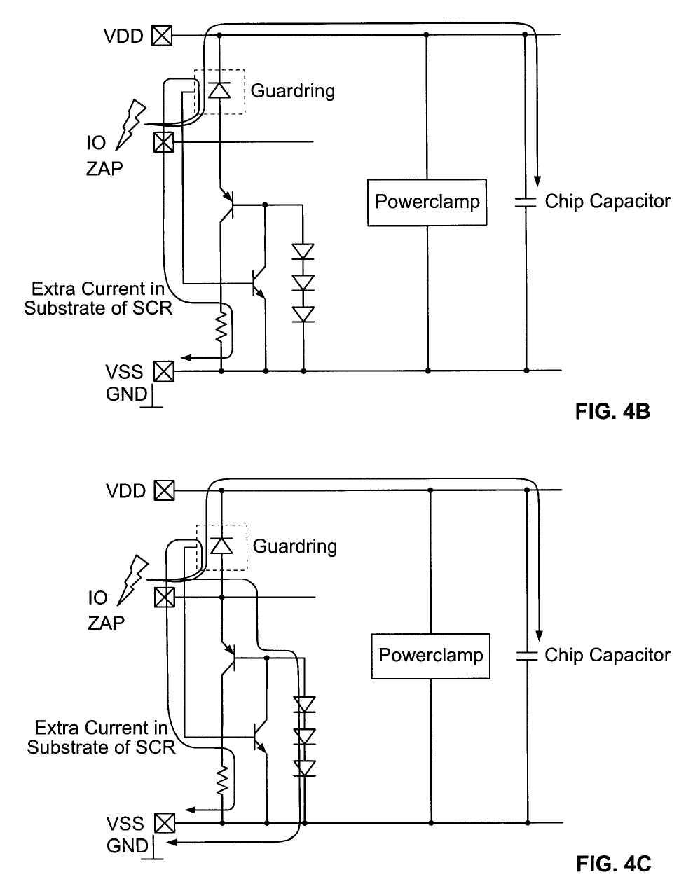

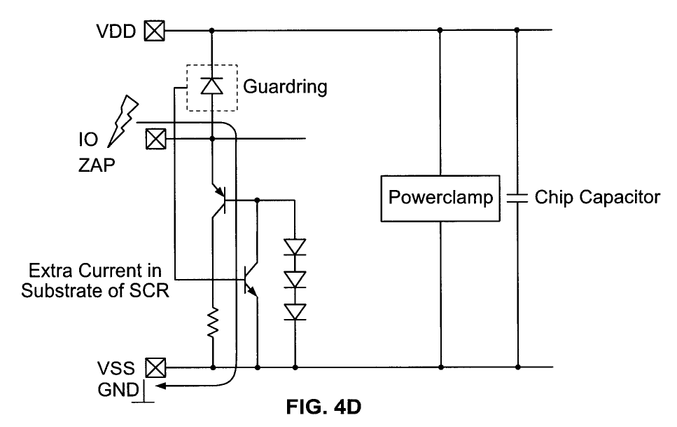

The present invention provides a new structure and technique to use the current flowing into the substrate to help the local clamp to trigger. Thus, use the current that a device injects in the substrate as an extra current to help an SCR to trigger as the trigger mechanism or as an additional way. A possible implementation is that instead of the guardring of the diode connecting to the Vss (ground) 110, the guardring is connected to a trigger tap of the SCR. This is illustrated in the ESD protection circuit 400 FIG. 4 as one embodiment of the present invention. As shown in FIG. 4, the guardring 116 is connected to at least one trigger tap of the SCR, preferably to a first trigger tap, G1 of the DTSCR 104. So, the current which is normally injected into the substrate will now be collected by the guardring 116 to trigger the ESD Clamp i.e. DTSCR 104, thus, causing the ESD clamp 104 to trigger much faster and easier. This is again due to the fact that the guardring 116 in this embodiment is connected to the first trigger tap G1 of the ESD clamp 104.

Referring to FIGS. 4A-4D, there is shown the direction of the current flow during an ESD event based on the circuit diagram 400 of FIG. 4. During an ESD-event, in the initial stage there flows a small current to the VDD line (powerline) 112 through the diode up 114 between the IO 108 and the VDD 112, as shown in FIG. 4A. Due to the inherent bipolar transistor a current will also flow to the guardring 116 of the pn junction diode-up 114, thus enough current will now be directed to G1 of the SCR 104′ and injected into the base of npn in the second stage as illustrated in FIG. 4B. As discussed in the prior art, this current is led away to the ground, but now, since the guardring 116 is connected to a trigger tap G1 of the SCR 104′, this will help to trigger the SCR 104′ much faster. The bulk of the SCR′ 104 will be pumped up to a higher voltage (i.e. current will flow through the resistive bulk of the well or substrate) and an initial voltage is built up over the trigger tap G1 resistor of the SCR′ 104. In the second stage, when the voltage at the IO 108 reaches the trigger voltage of the SCR′ 104, the SCR′ 104 will turn on. In the case of these figure (not limited to these figures), the trigger voltage is 3 times the built-in voltage of one of the series of pn junction diode 106 and the voltage over the base-emitter of the pnp of the SCR′ 104. So, in the third stage in FIG. 4C, the series of pn junction diodes 106 will begin conducting current, so current is also injected to G2 besides G1 because of overflow of the current. Thus, when there is enough current injected, all the current will be collected into the SCR′ 104 thus turning on the SCR 104′ (when the voltage over the base emitters of the npn and pnp reach about 0.7 volts) at fourth stage as illustrated in FIG. 4D. Thus, the same current line that is injected into the substrate is also injects the extra current into the SCR′ 104 due to the connection of the guardring 116 to the trigger tap (G1 in this example) of the SCR′ 104. It is important to note that even though the explanation is split in four steps, it's clear that all the events can be simultaneous at the same moment or in another order than described above. The extra current injected will cause that less current is needed through the trigger circuit and that the voltage overshoots can be reduced.

It is important to note that there may preferably include many implementations of the ESD protection circuit 400 of FIG. 4. One such implementation may include the diode-up connected to different G1 taps of one SCR or from different SCR. This could be useful for Charge Device Model (CDM) to trigger multiple clamps simultaneously. Another implementation is to connect different guardrings to the trigger taps of the one SCR. To prevent an increased leakage between two diodes, it's preferred to connect the different guardrings to different trigger taps to prevent current injection of one guardring into the other guardring, instead of in the SCR. The advantage of this technique is that there is an extra current injection into the SCR at an early stage of the ESD-pulse. This will make the SCR much faster. As discussed above, in prior art the SCR or the trigger circuit is sometimes too slow. The first consequence of the speed of the SCR are voltage overshoots seen by the protected circuit. Thus, the inventive aspect of the present invention as described with reference to FIG. 4 and FIGS. 4A-4D is to try to start or prepare the SCR earlier in the ESD-pulse and make so the SCR much faster.

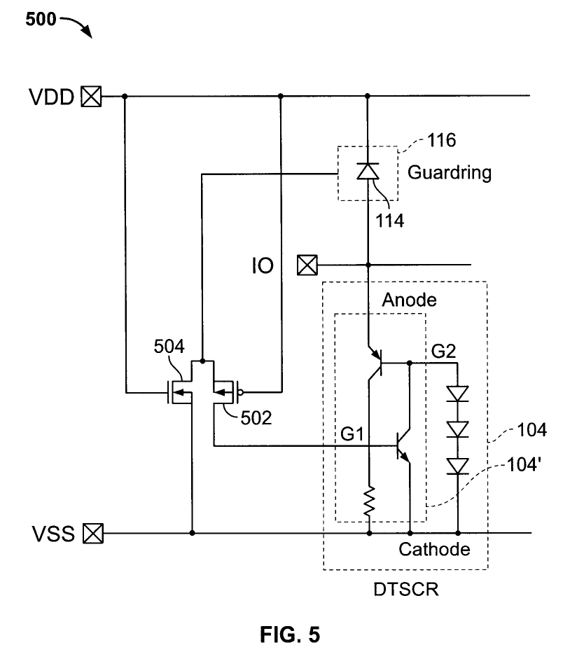

Further implementation of the ESD circuit 400 of FIG. 4 includes adding extra devices between the guardring 116 and a trigger tap of the SCR 10′ (DTSCR 104′) and between the guardring 116 and ground Vss 110. This implementation is illustrated in the ESD circuit 500 of FIG. 5 where a MOS transistor, in this example, a PMOS 502 is placed between the guardring 116 and the trigger tap, in this example, G1 of the SCR 104′, (DTSCR 104). Thus the trigger tap of the SCR 104′ (DTSCR 104) is connected to the Vdd 112. So, when the chip is unpowered the guardring 116 is connected to the SCR 104′ (DTSCR 104) to help the SCR to trigger, but during normal operation, the current will be blocked to prevent unwanted triggering. Moreover, another MOS transistor, in this example a NMOS 504 is added between the guardring 116 and the ground Vss 110. This functions to connect the guardring 116 to ground, Vss 110 during normal operation, but during ESD (non-powdered state) the current flow will be blocked. Alternatively, other elements can be placed between the guardband, ground./power and ESD clamp. One example is that a resistor (not shown) may be placed between the guardring 116 and ground Vss 110 which limits the current flow during ESD.

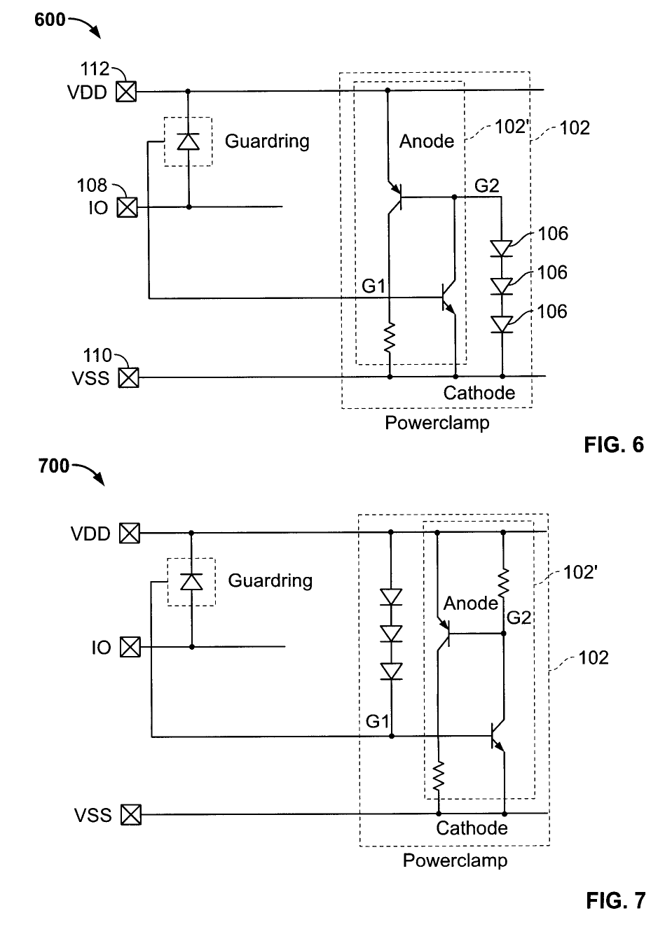

Those skilled in the art will understand that the above described technique isn't limited to a DTSCR 104 as a local clamp. Other local clamps based on an SCR are also possible. Furthermore, this technique is even not limited to local clamps but can be also be used in a powerclamp as seen in the ESD protection circuit 600 of FIG. 6. As seen in FIG. 6, the powerclamp 102 itself is a DTSCR 102 (with the SCR 102′) positioned between the Vdd 112 and the Vss 110, thus having Vdd 110 as the input voltage of the SCR. When ESD stress is between IO 108 and VSS 110, the current will flow through the diode 114 to the VDD line 112. Then the current will flow through the powerclamp to the VSS 110. In the initial phase these current will flow through the trigger circuit, i.e. the series of pn junction diodes 106. At the same time the current injected to the guardring 116 by the diode-up 114 will be directed to the G1 trigger tap of the powerclamp. As in the previous embodiment the current will flow now through two trigger taps to the SCR 102′. Thus a faster protection device is achieved.

In the previous FIG. 6, the current injection of the guardring 116 is done in a different trigger tap, i.e. G1 than where the trigger circuit is placed (G2), Somebody skilled in the art can easily adapt this so that the trigger circuit, i.e. the series of diodes 106 is at the same trigger tap as the current injection as shown in the alternate implementation of the ESD circuit 700 of FIG. 7. Thus, in the circuit 700 of FIG. 7 the trigger circuit, i.e. the series of diodes 106 is connected to the same trigger tap, i.e. G1 in this example, as the guardring 116. The technique can be described more generally to use the current that a device injects in the substrate as an extra current to help an SCR 104′ to trigger or as the current to help an SCR 104′ to trigger. Although not shown, the circuit 700 may not include the trigger circuit 106. In such a case, the SCR 104′ is triggered by the current injected by the device only.

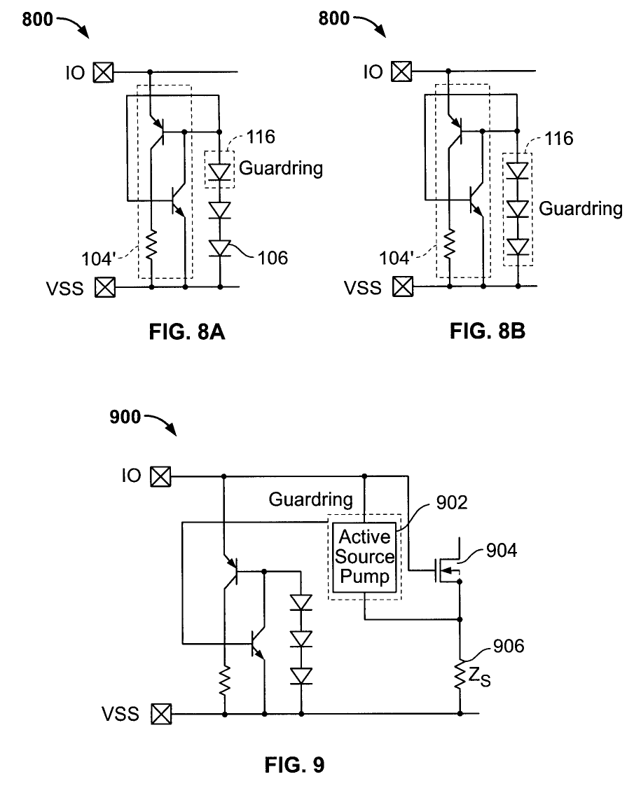

In the scope of this invention the local clamp 104 and the series of pn junction diodes 106 can be placed anywhere in the circuit. This preferably includes the top diode of the series of pn junction diodes 106 of the trigger circuit itself as the guardring 116 shown in ESD protection circuit 800 of FIG. 8A and FIG. 8B, as another alternate embodiment of the present invention. The guardring 116 may preferably be one of one the series of pn junction diodes 106 or of multiple diodes 106 as shown in FIG. 8B of the trigger circuit of the same ESD clamp 104.

Another implementation of the guardring is shown in the ESD protection circuit 900 of FIG. 9 in which the use of the guardring of one or more diodes (or other element) of an Active Source Pump scheme. As shown in FIG. 9, the guardring 116 is the active source pump element 902 located between the gate and the source of a MOS 904. The MOS 904 is the powerclamp 102 and Zs 906 is a resistance added in series to the source of the MOS 904. )The active source pump 902 is a circuit that clamps the voltage over the gate oxide of the MOS 904 by pumping current in the added resistance Zs 906 of the source to increase the voltage at this source. Thus the voltage between the gate and the source of the MOS 904 will be limited in response to the ESD event. Note that the active source pump 902 may preferably be a series of diodes, an NMOS detector circuit, a PMOS detector circuit etc.

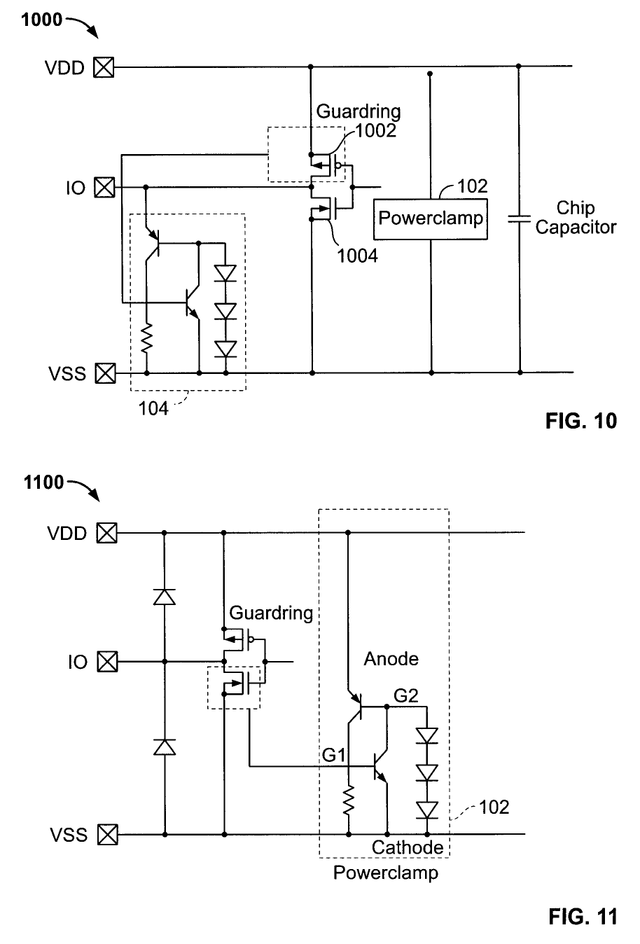

It is important to note that the guardring of the present invention is not limited to the well tap of the diodes only, but can also include other elements such as resistors, capacitors, MOS, SCR etc. One example is the use of the guardring 116 of the output of PMOS 1002 of an inverter stage as shown in the ESD protection circuit 1000 of FIG. 10. Alternatively, the use of the guardring 116 of the output of NMOS 1004 is shown in the ESD protection circuit 1100 of FIG. 11. As shown in FIG. 11, the guardring around the output of the NMOS 1004 is used to inject the current to the powerclamp 102. This technique could work without the presence of the local ESD clamp 104.

As discussed in detail above, the connection of the current injected to the substrate from the diode is lead to the SCR through a guardring. However, instead of using a guardring, a direct connection through the substrate is also possible. The pn junction diode-up 114 (can be different diodes as disclosed earlier in this document) can be preferably placed for this reason in a close proximity to the SCR 104′ as disclosed in the cross-section diagram of FIG. 12, thus forming a parasitic transistor. This distance is applicable to a minimum design rule, in other words, this is the smallest distance between the diode-up 114 and the SCR 104′ that meets the reliability guidelines. This close proximity is possible by eliminating the N+ region on the right side of the diode in FIG. 3 and thus the P+ region of diode-up 114 is very close to the N-well 204 and thus a transistor, i.e. parasitic transistor 1202 is formed. The parasitic transistor 1202 is a pnp transistor formed by the P+ 114a of the diode 114-up, N-well 204 of the diode 114 and the substrate 202 as shown in FIG. 12. The parasitic transistor 1202 has a smaller base length defined by the distance between P+ 114a of the diode 114-up and the substrate 202. This implies a higher multiplication factor and is thus a stronger transistor. The diode 114-up in FIG. 12 is thus placed near the first trigger tap, G1 to inject the current directly into the SCR 104′. Further improvement in this technique is also disclosed in FIG. 12 by reversing the order of the heavily p- and n-doped regions. Due the minimum distance between the P+ and the NWell edge (use of a single finger) the horizontal npn is the strongest bipolar transistor available. Moreover, instead of using two fingers, a single or multiple fingers layouts are also possible in the ESD protection circuits.

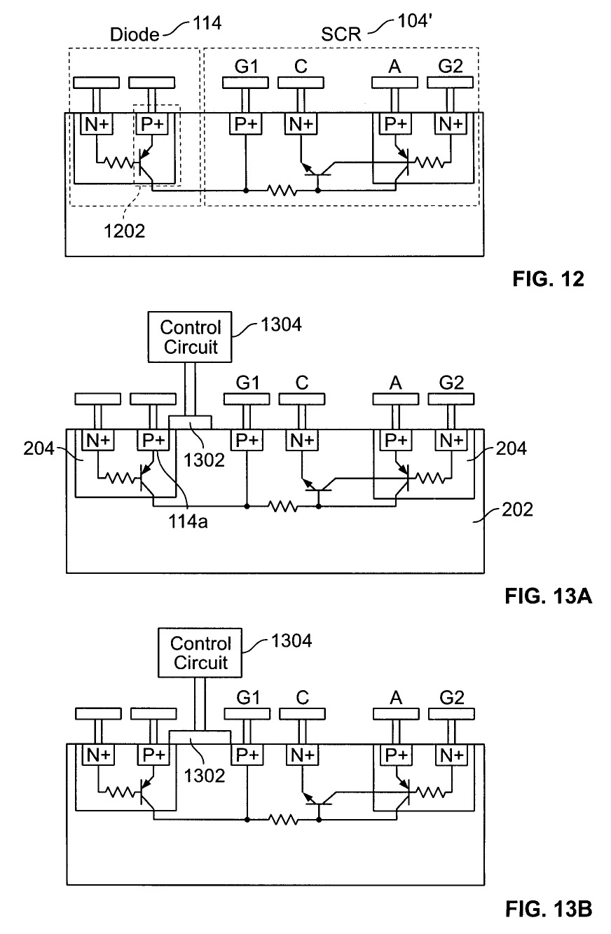

Although not shown in the previous figures, an isolation such as an STI is provided between the P+ of the diode-up (N-well diode) 114 and the p+ of the G1 of the SCR 104′ which prevents some of the current to flow from the diode to the substrate. So, besides using the current of the parasitic bipolar transistor, it is also preferable to increase the current flowing from the diode to the substrate. This corresponds with making more Si area available for the current through the parasitic bipolar transistor. A possible technique of this implementation is illustrated in the cross-section diagrams of FIG. 13A and FIG. 13B in accordance with further embodiment of the present invention. As shown in FIGS. 13A and 13B, a gate 1302, preferable a gate oxide, is placed over the border of the Nwell 204 and the Pwell substrate 202. This causes the available edge between the Nwell 204 and the P-well substrate 202 to be much larger, thus additional current can be injected from the Nwell 204 into the substrate 202 for triggering of the gate oxide 1302 at G1 tap of the SCR 104′. The reason for the large edge is that under the gate oxide 1302, no isolation is formed. With the placement of the gate 1302, a MOS transistor channel is formed between the p-doped region 114a of the diode-up 114 (or another element like a MOS, other diodes) and the Pwell or substrate 202. The gate of the transistor can be controlled so that during ESD, the MOS is turned on and during normal operation the MOS is turned off to prevent high leakage. As seen in one implementation of FIG. 13A, gate 1302 is between P-doped region of diode-up 114 and substrate 202, Isolation is still formed between this point and the G1 trigger tap of the SCR 104′. In another implementation of FIG. 13B, gate 1302 is between P-doped region of diode-up 114 and a first trigger tap G1 of the SCR 104′, where the STI is completely eliminated. Additionally, as shown in FIGS. 13A and 13B, a controlled circuit 1302 is connected to the gate oxide. The control circuit 1302 functions to keep the MOS transistor in an “off” state during normal operation and in an “on” state during ESD. This is done by controlling the voltage at the gate 1302 as described in greater detail below.

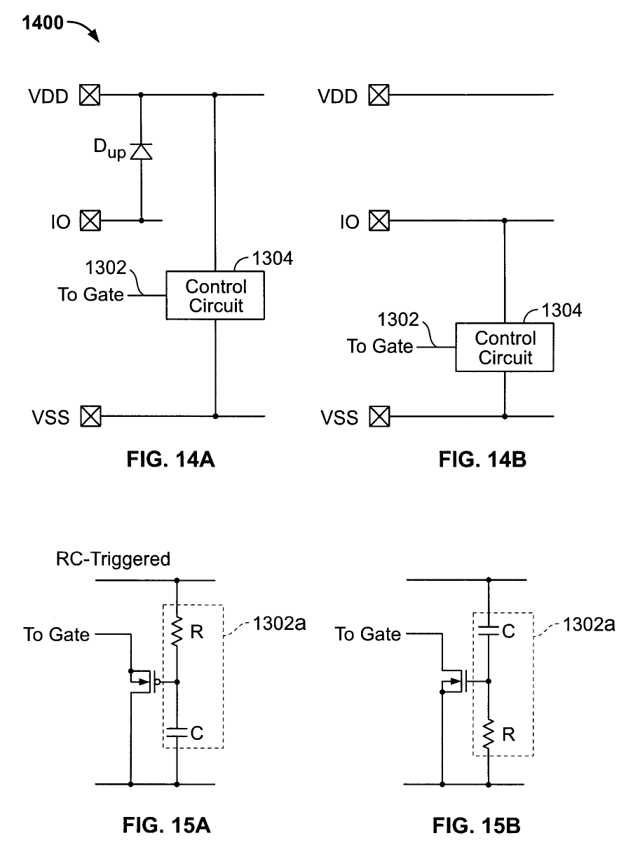

Referring to FIGS. 14A and 14B, there are shown various positions of placing the control circuit 1302 in an ESD protection circuit 1400 in accordance with even further embodiment of the present invention. The control circuit 1302 can be placed at the IO pin 108, between the two power lines, i.e. Vdd 112 and Vss(ground) 110 as shown in FIG. 14A. Alternatively, the control circuit 1302 can be placed between the IO pin 108 and Vss 110 without being connected to any additional power lines as illustrated in FIG. 14B. The advantage of the technique in FIG. 14A is that control circuit 1304 is enough to provide a gate voltage to different IO-pins. The advantage of FIG. 14B is that the control circuit 1304 can be made smaller since there is less influence of the diode up which has a negative impact on the control circuit.

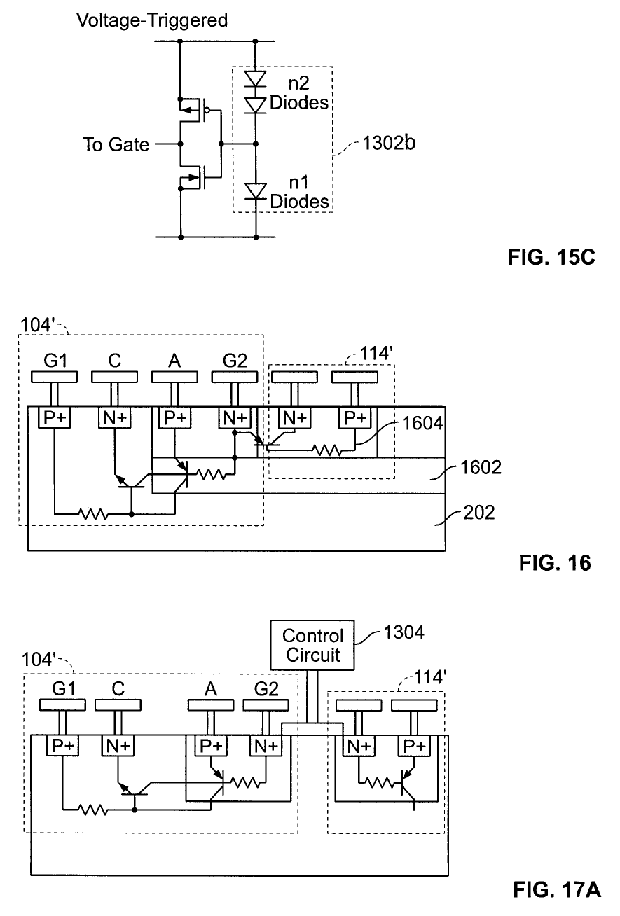

Some examples of various kinds of control circuit are shown in FIGS. 15A through 15C. One such control circuit 1302 is the RC-triggered 1302a based on delay alone existing at least of a resistor and capacitor as shown in FIG. 15A and FIG. 15B. One skilled in the art would understand that there exist a lot of techniques to provide a control circuit having inverter stages, feedback etc. The second possible implementation of the control circuit is based on a voltage detection circuit. One such example is shown in FIG. 15C, where the control circuit 1302 is a string of diodes 1302b. Other possible implementations of the control are short or open circuits, current detector circuits etc.

Furthermore, the above-identified invention with respect to the figures described above is also not limited to inject current in a G1 trigger tap of the SCR 104′. As shown in FIG. 16. If a deep NWell 1602 is available, it is also possible to make the similar case (as in previous figures) instead with a P-well diode, i.e. the diode-up 114′ in the isolated P-Well 1602 and the Nwell 204 of the SCR 104′. This forms a parasitic npn transistor which injects current into the Nwell 204 of the SCR 104′. So in this case in FIG. 16, the current in the isolated P-well 1602 is injected into the G2 trigger tap as opposed to the G1 trigger tap shown in previous figures.

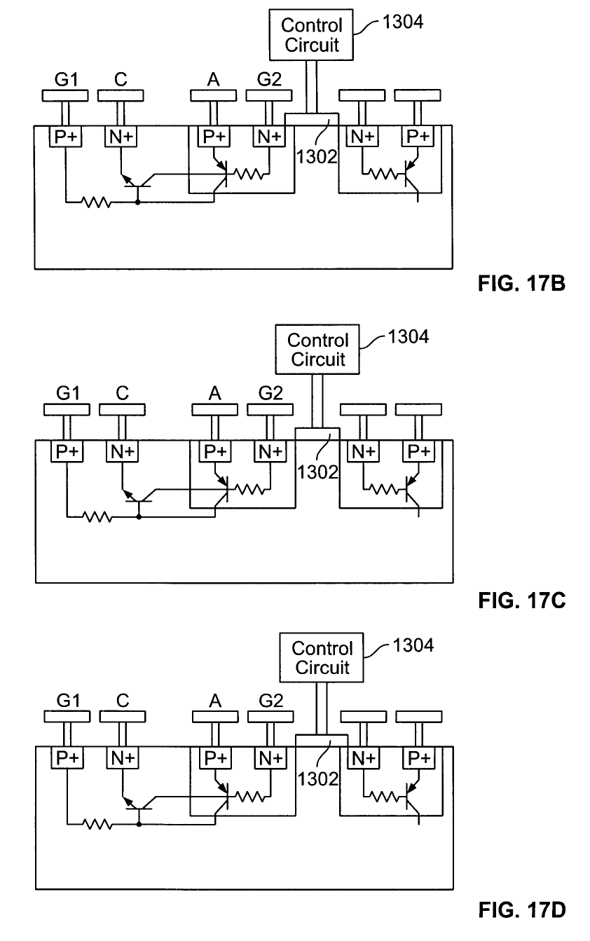

Even the current from a Nwell-diode-up 114″ can be injected in the NWell of the SCR. 104′ Referring to FIGS. 17A-17C, there is shown various implementations of the position of the gate oxide 1302 and the control circuit 1304 of FIG. 13 with respect to the Nwell diode-up 114″. FIGS. 17A-17C illustrate implementations with respect to N-well diode-up 114″ with current injected into the G2 trigger tap of the SCR 104′. Thus, the gate oxide 1302 and the control circuit 1304 of FIGS. 17A-17C are used to inject current from N-well diode-up 114″ into the N-well of the SCR 104′ thus triggering the gate oxide 1302 at G2 tap of the SCR 104′. So, FIGS. 17A-17C shows four implementations with four possible positions of the gate 1302 to inject current in G2- tap or Nwell of the SCR 104′. As seen in FIG. 17A, the gate oxide 1302 is positioned between and adjacent to the two N+ regions, i.e. the N+ region of the SCR 104′ and the N+ regions of the N-well diode-up 114″. In FIG. 17B, the gate oxide 1302 is placed between and adjacent to the N+ region of the SCR 104′ and adjacent to the Nwell diode-up 114″, also including some portion of the N+ region of the SCR 104′. In, FIG. 17C, the gate oxide 1302 is connected between and adjacent to the Nwell of the SCR 104′ and adjacent to the N-well diode-up 114″. Furthermore, in FIG. 17D, the gate oxide 1302 is placed between and adjacent to the Nwell of the SCR 104′, and the N+ region of the diode-up 114′.

Thus, the above described invention provides various techniques to use the current that a device injects in the substrate as an extra current to help SCR to trigger. Such techniques as described in detail above include use of the inherent bipolar transistor, via a guardring, improvements of the inherent bipolar transistor, positioning of the bipolar transistor, improvements to increase the current flowing into the substrate during ESD. Note that one skilled in the art would easily see that the invention is not limited to the implementations shown in the present invention. For example, the above described invention is illustrated as the P doped guardring, however, one skilled in the art can preferably implement this with a N doped guardband (with or without a Nwell around).

Although various embodiments that incorporate the teachings of the present invention have been shown and described in detail herein, those skilled in the art can readily devise many other varied embodiments that still incorporate these teachings without departing from the spirit and the scope of the invention.

1. An electrostatic discharge (ESD) protection circuit comprising:
a SCR having at least one interspersed high-doped first region formed within a first lightly doped region and at least one interspersed high-doped second region formed within a second lightly doped region, said SCR coupled between a first voltage potential and a second voltage potential; and
at least one guardring coupled to at least one trigger tap of the SCR.

2. The ESD protection circuit of claim 1 wherein said guardring comprise the well tap of at least one of a resistor, a capacitor, a diode, a MOS, a SCR and an active source pump.

3. The ESD protection circuit of claim 1 further comprising at least one series pn junction diode having an anode and a cathode respectively coupled in the forward direction from at least one trigger tap of the SCR to the second voltage potential.

4. The ESD protection circuit of claim 3 wherein the guardring surrounds at least one of the at least one series pn junction diodes.

5. The ESD protection circuit of claim 1 wherein the first voltage potential is at least one of an input, output and input/output pad.

6. The ESD protection circuit of claim 5 wherein the second voltage potential is the ground.

7. The ESD protection circuit of claim 6 further comprising a third voltage potential, wherein said third voltage potential is a power supply.

8. The ESD protection circuit of claim 7 further comprising a pn junction diode coupled between the first voltage potential and the third voltage potential.

9. The ESD protection circuit of claim 8 wherein the at least one guardring surrounds the said pn junction diode.

10. The ESD protection circuit of claim 1 wherein the first voltage potential is an power supply and the second voltage potential is the ground.

11. The ESD protection circuit of claim 10 further comprising a third voltage potential, wherein said third voltage potential is at least one of an input, output and input/output pad.

12. The ESD protection circuit of claim 11 further comprising a pn junction diode coupled between the third voltage potential and the first voltage potential.

13. The ESD protection circuit of claim 11 wherein said at least one guardring surrounds the pn junction diode.

14. The ESD protection circuit of claim 1 further comprising a first MOS coupled between the at least one guardring and the trigger tap of the SCR.

15. The ESD protection circuit of claim 14 further comprising a second MOS coupled between the at least one guardring and one of said first and second voltage potential, wherein said one of the first and second voltage potential is ground.

16. The ESD protection circuit of claim 15 wherein the first MOS is a NMOS and the second MOS is a PMOS and the gate of the first and the second NMOS are coupled to a power supply.

17. An integrated circuit having a substrate comprising:
a SCR formed over the said substrate, said SCR having at least one interspersed high-doped first region formed within a first lightly doped region and at least one interspersed high-doped second region formed within a second lightly doped region; and
a pn junction diode directly connected to said SCR without a guardring between the SCR and pn junction.

18. The circuit of claim 17 wherein a gate is formed between the at least one interspersed high doped region of the diode and the substrate.

19. The circuit of claim 18 further comprising a control circuit connected to said gate.

20. The circuit of claim 19 wherein said control circuit is coupled between a first voltage potential and a second voltage potential.

21. The circuit of claim 19 wherein said control circuit comprises at least one of a RC circuit, voltage detection circuit, current detection circuit, short circuit and open circuit.

22. The circuit of claim 17 wherein a gate is formed between the at least one interspersed high doped region of the diode and at least one trigger tap of the SCR.

23. The circuit of claim 22 further comprising a control circuit connected to said gate.

24. The circuit of claim 1 wherein said control circuit is coupled between a first voltage potential and a second voltage potential.

25. The circuit of claim 22 wherein said control circuit comprises at least one of a RC circuit, voltage detection circuit current detection circuit, short circuit and open circuit.
